(19) United States
(12) Patent Application Publication
(10) Pub. No.: US 2006/0273843 A1
(43) Pub. Date: Dec. 7, 2006

(54) High efficiency bi-directional charge pump circuit

(76) Inventors: Jean-Michel Daga, Rousset (FR); Emmanuel Racape, Aix-en-Provence (FR)

Correspondence Address: SCHNECK & SCHNECK, P.O. BOX 2-E, SAN JOSE, CA, 95109-0005, US

(21) Appl. No.: 11/221,309

(22) Filed: Sep. 7, 2005

(30) Foreign Application Priority Data
Jun. 3, 2005 (FR) 05/05652

(51) Int. Cl. G05F 1/10

(52) U.S. Cl. 327/536

(57) ABSTRACT

A charge pump circuit having a first voltage node acting as an input when the charge pump circuit boosts negative voltages, and acting as an output when the charge pump circuit boosts positive voltages and a second voltage node acting as an input when the charge pump circuit boosts positive voltages, and acting as an output when the charge pump circuit boosts negative voltages. The charge pump circuit further has a first pump capacitor, a second pump capacitor, a first auxiliary capacitor, and a second auxiliary capacitor.

### TECHNICAL FIELD

The present invention is related to integrated circuits. More specifically, the present invention is an apparatus and method for a voltage charge pump circuit.

### BACKGROUND ART

Charge pump circuits are commonly used to provide high positive and negative voltages in applications such as programming of Flash memories. The conventional approach is to employ separate charge pump circuits, one for the generation of positive voltage, and another for the generation of negative voltage. Typical charge pump circuits comprise a significant portion of the silicon area of a Flash memory circuit. If high positive and negative voltages are not simultaneously required, a reversible, bi-directional charge pump capable of generating both positive and negative voltages becomes an attractive opportunity to provide area and cost savings.

A popular approach to the creation of a voltage charge pump in the prior art is embodied in an architecture known as the Dickson charge pump. FIG. 1 is a circuit schematic of a positive voltage charge pump circuit as proposed by Dickson in a technical paper entitled “On-chip high-voltage generation in NMOS integrated circuits using an improved voltage multiplier technique.” The charge pump has multiple stages, each stage consisting of a capacitor and an NMOS transistor acting as a diode. The NMOS stage transistors have their bulk terminals connected to the circuit ground, their drain and gate terminals connected to the stage capacitor, and their source terminals connected to the capacitor of the next stage. Two inverted phase clocks are employed to drive the pump. The maximum gain per stage is V_{DD}−Vₜ, where V_{DD} is the system potential and Vₜ is the threshold voltage of the NMOS devices. As the system potential V_{DD} decreases with advanced fabrication technologies, the efficiency of the charge pump is decreased. Moreover, the well-known body effect increases the effective threshold voltage of the NMOS devices as the potential between the source and bulk terminals increases, thereby limiting the number of stages that can be effectively cascaded. Another drawback of the prior art charge pump is that thick oxide (high voltage) transistors are required to withstand the large potential differences developed between the gate and bulk terminals. Without the use of thick oxide devices, reliability would be compromised. The necessity for thick oxide transistors makes design with standard thin oxide (low voltage) transistors impossible, adding to process complexity and cost.

Improvements have been made to the Dickson architecture to ameliorate some of the shortcomings outlined above. For example, the gain degradation due to the threshold voltage dependence is mitigated by use of a four phase clocking approach, as presented in a technical paper entitled “New four-phase generation circuits for low-voltage charge pumps” by Hongchin Lin and Nai-Hsien Chen. Lin and Chen achieved a 9 V output from a ten-stage charge pump provided with a 1 V input.

In a technical paper entitled “A New 4-Phase Charge Pump Without Body Effects for Low Supply Voltages” by Hongchin Lin, JainHao Lu and Yen-Tai Lin a charge pump employs PMOS transistors fabricated in a triple-well structure on an n-type substrate. Those skilled in the art will appreciate that this device/substrate combination is not commonly employed as p-type substrates are widely preferred for commercial application due to latch-up resistance, cost, availability, and other performance attributes. Furthermore, the Lin, Lu and Lin circuit requires a fifth clock (φ₀) to precharge the n-wells in order to prevent forward biasing of the n-well diode. Finally, both the Chen and Lin paper and the Lin, Lu, and Lin paper teach the application of PMOS transistors for fabrication of negative voltage boosting charge pumps, and use of NMOS transistors for the 10 fabrication of positive voltage boosting charge pumps.

In U.S. Pat. No. 6,677,805 to Shor et al., (“the '805 patent”) a charge pump configuration is disclosed which intends to limit loss of efficiency by virtue of the body-bias effect. However, a transfer transistor and an auxiliary transistor in the '805 patent are configured with their bulk terminals decoupled from their source terminals. Thus, the source-to-bulk potentials of these devices may vary, necessitating the use of (thick oxide) high voltage transistors if the potential difference becomes sufficiently large. The '805 patent further discloses that NMOS transistors are preferentially employed to fabricate positive voltage charge pumps and PMOS transistors are preferentially employed to fabricate negative voltage charge pumps.

What is needed is a charge pump circuit which is substantially immune to threshold voltage dependence and body-bias gain degradation. Furthermore, a single circuit design usable for both positive and negative voltage charge pumps is desirable. Finally, the circuit should not require special device configurations (thick oxide, or PMOS triple well) which necessitate additional fabrication complexity and increased cost.

### SUMMARY OF THE INVENTION

The present invention is an apparatus and method for a voltage charge pump which solves the problems inherent in the prior art. A charge pump, fabricated in a standard CMOS process on a p-type substrate utilizing a triple-well NMOS transistor structure, with high efficiency and capability of boosting both positive and negative potentials is introduced in the present invention. The charge pump requires only thin oxide (low voltage) transistors, simplifying implementation and expanding the opportunity for its application in a variety of process technologies. The present invention reduces the silicon area requirement in a Flash memory by providing a source of both elevated positive and negative voltages with a single circuit. Furthermore, the present invention can be applied to other applications and circuits where elevated voltages are required.

### BRIEF DESCRIPTION OF THE DRAWINGS

FIG. 1 is a circuit schematic of a positive voltage charge pump circuit as known in the prior art.

FIG. 2A is an exemplary circuit schematic of a charge pump stage according to the present invention.

FIG. 2B is a block diagram of a charge pump stage according to an exemplary embodiment of the present invention.

FIG. 3 is a conceptual timing diagram for charge pump clock signals according to an exemplary embodiment of the present invention.

FIG. 4A is a positive voltage cascaded charge pump according to an exemplary embodiment of the present invention.

FIG. 4B is a negative voltage cascaded charge pump according to an exemplary embodiment of the present invention.

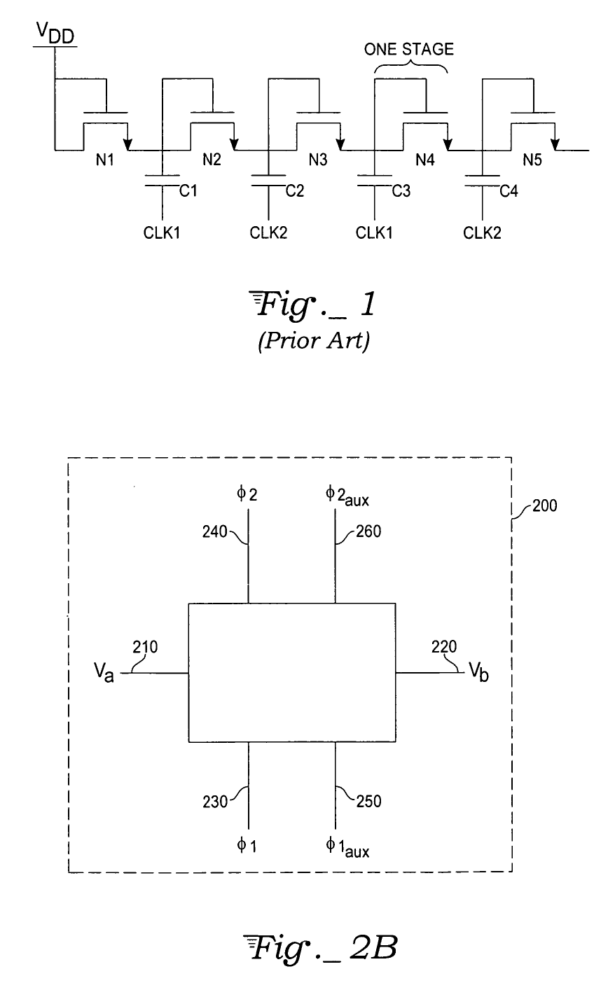

### DETAILED DESCRIPTION OF THE INVENTION

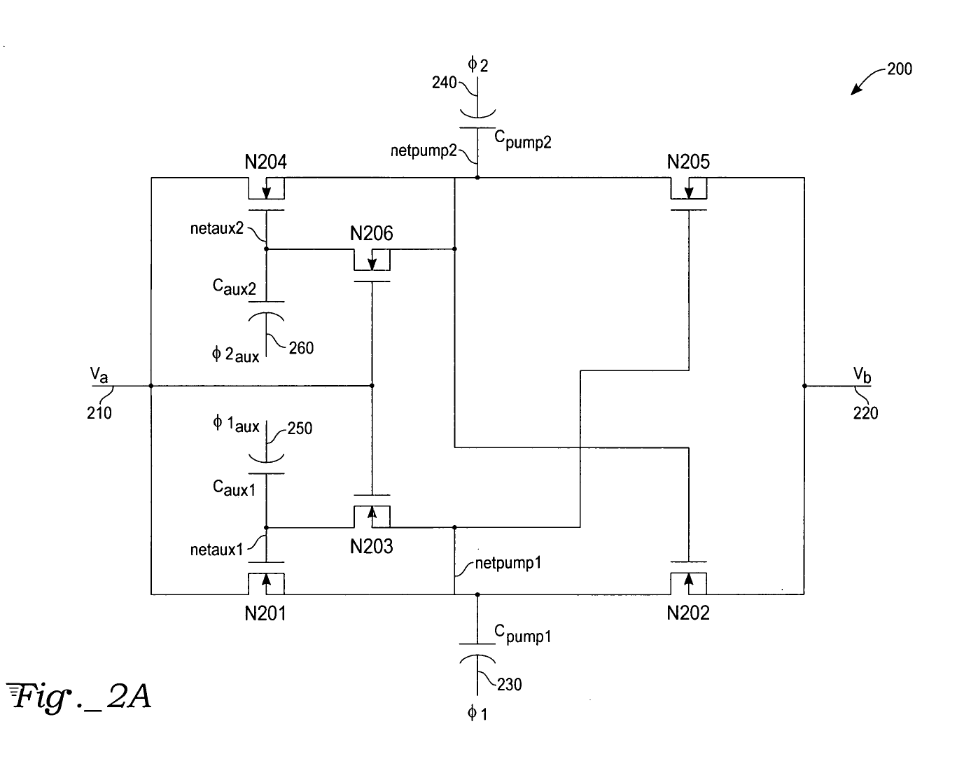

With reference to FIG. 2A, a charge pump stage 200 according to an exemplary embodiment of the present invention comprises a first voltage input/output node 210 associated with a potential Vₐ, a second voltage input/output node 220 associated with a potential V_{b}, a first control clock node 230 associated with a clock signal φ1, a second control clock node 240 associated with a clock signal φ2, a first auxiliary control clock node 250 associated with a clock signal φ1ₐᵤₓ, and a second auxiliary control clock node 260 associated with a clock signal φ2ₐᵤₓ. The charge pump stage 200 further comprises NMOS transistors N201-N206. In an exemplary embodiment of the present invention, the NMOS transistors N201-N206 are low-voltage devices, each implemented within a triple-well structure. The methods of fabricating triple-well NMOS transistors are well known to those skilled in the art and will not be articulated here to avoid obscuring the present invention. Skilled artisans will appreciate that a deep n-well of the triple-well structure is coupled to the highest potential applied to the charge pump stage 200 in order to prevent forward conduction of a diode formed by the deep n-well and the p-type substrate. In the exemplary embodiment, the deep n-well of the triple-well structure is coupled to the first voltage input/output node 210.

The first voltage input/output node 210 is coupled to the drain terminals of the NMOS transistors N201 and N204, and to gate terminals of the NMOS transistors N203 and N206. The gate terminal of the NMOS transistor N201, the drain terminal of NMOS transistor N203, and a first terminal of a first auxiliary capacitor Cₐᵤₓ₁ are coupled to each other and to an auxiliary node netaux1. A second terminal of the first auxiliary capacitor Cₐᵤₓ₁ is coupled to the first auxiliary control clock node 250 receiving the auxiliary control clock signal φ1ₐᵤₓ. The gate terminal of the NMOS transistor N204, the drain terminal of NMOS transistor N206, and a first terminal of a second auxiliary capacitor Cₐᵤₓ₂ are coupled to each other and to an auxiliary node netaux2. A second terminal of the second auxiliary capacitor Cₐᵤₓ₂ is coupled to the second auxiliary control clock node 260 receiving the auxiliary control clock signal φ2ₐᵤₓ. In the exemplary embodiment of the present invention, the first auxiliary capacitor Cₐᵤₓ₁ and the second auxiliary capacitor Cₐᵤₓ₂ are symmetrical counterparts and similarly sized.

The bulk terminal and the source terminal of the NMOS transistor N202 are coupled to each other and to the second voltage input/output node 220. The bulk terminal and the source terminal of the NMOS transistor N205 are coupled to each other and to the second voltage input/output node 220. The source terminal and the bulk terminal of the NMOS transistor N201 are coupled to each other, to a first pumping node netpump1, and to the source terminal and the bulk terminal of the NMOS transistor N203. The first pumping node netpump1 is further coupled to the drain terminal of the NMOS transistor N202, to the gate terminal of the NMOS transistor N205, and to a first terminal of a first pump capacitor Cpump1. A second terminal of the first pump capacitor Cpump1 is coupled to the first control clock node 230 receiving the associated control clock signal φ1.

The source terminal and the bulk terminal of the NMOS transistor N204 are coupled to each other, to a pumping node netpump2, and to the source terminal and the bulk terminal of the NMOS transistor N206. The second pumping node netpump2 is further coupled to the drain terminal of the NMOS transistor N205, to the gate terminal of the NMOS transistor N202, and to a first terminal of a second pump capacitor Cpump2. A second terminal of the second pump capacitor Cpump2 is coupled to the second control clock node 240 receiving the associated control clock signal φ2. In a specific exemplary embodiment of the present invention, the first pump capacitor Cₚᵤₘₚ₁ and the second pump capacitor Cₚᵤₘₚ₂ are symmetrical counterparts and approximately equally sized.

The first auxiliary capacitor Cₐᵤₓ₁, the second auxiliary capacitor Cₐᵤₓ₂, the first pump capacitor Cₚᵤₘₚ₁ and the second pump capacitor Cₚᵤₘₚ₂ may be fabricated by a plurality of methods well known to skilled artisans. For example, the capacitors may be passive component structures integrated as part of a process technology such as metal-insulator-metal devices, they may be based upon MOS transistor structures, or they may comprise other possible configurations known in the art.

FIG. 2B is a block diagram illustrating the electrical connection points of the charge pump stage 200. Those skilled in the art will appreciate that the block diagram provides a convenient technique for illustrating the charge pump stage 200 in a plurality of instantiations, to be described infra, or to other circuits.

Operation as a Positive Charge Pump

In the exemplary embodiment of the present invention operating as a positive charge pump, the potential V_{b} is applied to the second voltage input/output node 220 as an input. In the exemplary embodiment, the potential V_{b} is the same as a system potential V_{DD} provided for circuit operation. The system potential V_{DD} is referenced with respect to a ground potential GND, which nominally is zero volts.

With reference to both FIGS. 2A and 2B, the potential Vₐ is produced at the first voltage input/output node 210 as an output. The first pump capacitor Cₚᵤₘₚ₁ and the second pump capacitor Cₚᵤₘₚ₂ provide required charge storage for the basic pumping operation. The NMOS transistors N201 and N204 are used to transfer charge from the pumping nodes netpump1 and netpump2 respectively to the first voltage input/output node 210. By diode action, the NMOS transistors N201 and N204 further prevent reverse current feedback from the first voltage input/output node 210 to the pumping nodes netpump1 and netpump2. The NMOS transistor N202 is used to couple the first pumping node netpump1 to the potential V_{b} when the first pump capacitor Cpump1 is not pumped, i.e., when the control clock signal φ1 is low. Analogously, the NMOS transistor N205 is used to couple the second pumping node netpump2 to the potential V_{b} when the second pump capacitor Cpump2 is not pumped, that is, when the control clock signal φ2 is low.

The NMOS transistor N203 is used to switch the gate terminal of the NMOS transistor N201 to the input pump node potential, i.e., the potential V_{b}, when the first pump capacitor Cₚᵤₘₚ₁ is not boosted. In this condition, the NMOS transistor N201 has its drain terminal at approximately the potential Vₐ, and its gate, source, and bulk terminals at approximately the potential V_{b}. Since the potential Vₐ is more positive than the potential V_{b}, the NMOS transistor N201 is biased off, preventing conduction between the first voltage input/output node 210 and the first pumping node netpump1.

Analogously, the NMOS transistor N206 is used to switch the gate terminal of the NMOS transistor N204 to the input pump node potential, i.e., the potential V_{b}, when the second pump capacitor Cₚᵤₘₚ₂ is not boosted. In this condition, the NMOS transistor N204 has its drain terminal at approximately the potential Vₐ, and its gate, source, and bulk terminals at approximately the potential V_{b}. Since the potential Vₐ is more positive than the potential V_{b}, the NMOS transistor N204 is biased off, preventing conduction between the first voltage input/output node 210 and the second pump node netpump2.

The first auxiliary capacitor Cₐᵤₓ₁ is used to generate an over-shoot potential exceeding the potential Vₐ on the gate of the NMOS transistor N201. This produces a strong turn-on condition in the NMOS transistor N201 when charges are being transferred from the first pumping node netpump1 to the first voltage input/output node 210. The second auxiliary capacitor Cₐᵤₓ₂ is used to generate an over-shoot potential exceeding the potential Vₐ on the gate of the NMOS transistor N204. This produces a strong turn-on condition in the NMOS transistor N204 when charges are being transferred from the second pumping node netpump2 to the first voltage input/output node 210.

In steady state, the first pumping node netpump1 varies in potential between the potential V_{b} and V_{b}+Cᵣ₁×V_{DD}, where:

$${C}_{r 1} = \frac{1}{1 + \frac{{C}_{par 1}}{{C}_{pump 1}}} \qquad ( 1 )$$

In formula (1), Cₚₐᵣ₁ is the total parasitic capacitance at the first pumping node netpump1 due to capacitance associated with the NMOS transistors N201, N202, N203, and N205. In a specific exemplary embodiment of the present invention, the first pump capacitor Cₚᵤₘₚ₁ is chosen so that Cₚᵤₘₚ₁>>Cₚₐᵣ₁. As a result, Cᵣ₁ is approximately equal to unity. Under these conditions, the first pumping node netpump1 varies in potential approximately between the potential V_{b} and V_{b}+V_{DD}. Analogously, the potential of the second pumping node netpump2 also varies approximately between the potential V_{b} and V_{b}+V_{DD}, since the second pump capacitor Cpump2 and the first pump capacitor Cₚᵤₘₚ₁ are approximately equally sized. During the pumping of the first pumping node netpump1, while control clock signal φ1 is high, but auxiliary control clock signal φ1ₐᵤₓ is low, the auxiliary node netaux1 achieves a potential Vₐᵤₓ=Vₐ−Vₜ, where Vₜ is the threshold voltage of the NMOS transistors used to fabricate the charge pump stage 200. When φ1ₐᵤₓ subsequently transitions high, the potential at the auxiliary node netaux1 is driven to an overshoot value V_{high}, where V_{high}=Vₐᵤₓ+Cᵣ₂×V_{DD} and:

$${C}_{r 2} = \frac{1}{1 + \frac{{C}_{par 2}}{{C}_{aux 1}}} \qquad ( 2 )$$

In formula (2), Cₚₐᵣ₂ is the total capacitance at the auxiliary node netaux1 due to the NMOS transistors N201 and N203. In a specific exemplary embodiment of the present invention, functional operation is achieved by satisfying the condition that Cᵣ₂×V_{DD}>Vₜ. When the auxiliary control clock signal φ1ₐᵤₓ transitions low, the auxiliary node netaux1 returns to the potential Vₐᵤₓ, turning the NMOS transistor N201 off. At the end of the pumping operation, control clock signal φ1 goes low, causing the first pumping node netpump1 and the auxiliary node netaux1 to each decrease in potential to approximately the potential V_{b}. Due to the symmetrical construction of the charge pump stage 200, the potential variation at the auxiliary node netaux2 is completely analogous to that described supra, with the exception that the pumping action is controlled by the action of the control clock signal φ2 and the auxiliary control clock signal φ2ₐᵤₓ operating on NMOS transistors N204 and N206.

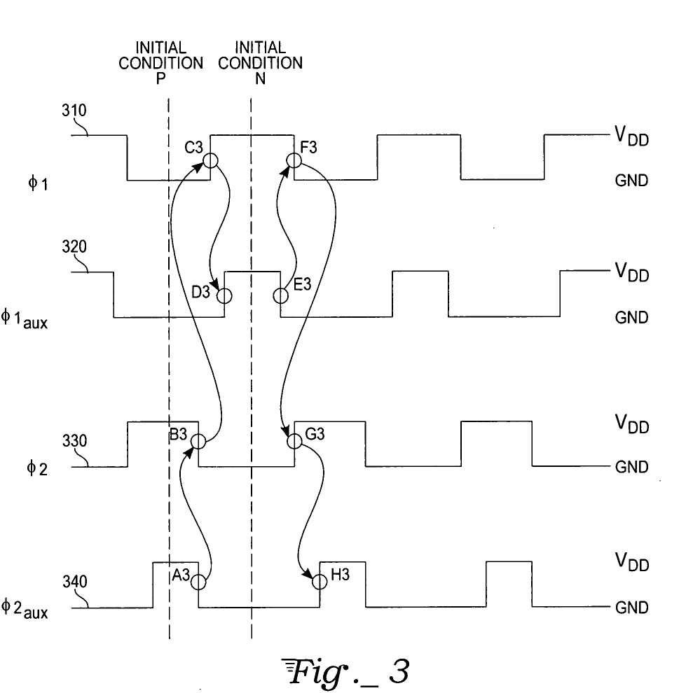

Additional details of the operation of the charge pump stage 200 as a positive voltage charge pump will now be further explained with reference to FIG. 3, comprising φ1 timing waveform 310, φ1ₐᵤₓ timing waveform 320, φ2 timing waveform 330, and φ2ₐᵤₓ timing waveform 340. All four timing waveforms have a high condition corresponding to approximately the system potential V_{DD}, and a low condition corresponding to approximately the ground potential GND. Switching transitions A3-H3, to be further explained infra, are associated with changes in the timing waveforms. Those skilled in the art will appreciate that the switching transitions A3-H3 are repetitive and that the specific transitions marked are selected to illustrate the present invention without obscuration.

Starting from an initial condition P where the control clock signal φ1 and the auxiliary control clock signal φ1ₐᵤₓ are low and the control clock signal φ2 and the auxiliary control clock signal φ2ₐᵤₓ are high, the second pumping node netpump2 is at a potential of approximately V_{b}+V_{DD}, the auxiliary node netaux2 is at the potential of approximately V_{high}, the first pumping node netpump1 is approximately the potential V_{b}, and the auxiliary node netaux1 is approximately the potential V_{b}. During a switching transition A3 the auxiliary control clock signal φ2ₐᵤₓ transitions low, causing the auxiliary node netaux2 to decrease from the potential of approximately V_{high} to the potential of approximately Vₐᵤₓ, biasing the NMOS transistor N204 off. At a switching transition B3, the control clock signal φ2 transitions low, causing the second pumping node netpump2 to decrease to approximately the potential V_{b}. The potential of the auxiliary node netaux2 is also decreased to approximately the potential V_{b} by coupling to the second pumping node netpump2 through the NMOS transistor N206. Because the second pumping node netpump2 is now approximately at the potential V_{b}, the NMOS transistor N202 is biased off. The NMOS transistors N201 and N205 have their gate terminals at approximately the potential V_{b} and are biased off, thereby preventing a reverse charge transfer from the first voltage input/output node 210 (at approximately the potential Vₐ) to the first pumping node netpump1 and from the second pumping node netpump2 to the second voltage input/output node 220 (at approximately the potential V_{b}).

At a switching transition C3, the control clock signal φ1 transitions high (to approximately the system potential V_{DD}), causing the first pumping node netpump1 to rise to approximately V_{b}+V_{DD}, biasing the NMOS transistor N205 on and enabling charge transfer from the second voltage input/output node 220 to the second pumping node netpump2, readying the second pumping node netpump2 for its next pump cycle. Concurrently, the auxiliary node netaux1, coupled to the first pumping node netpump1 by the NMOS transistor N203, is pumped to approximately the potential Vₐᵤₓ.

At a switching transition D3, the auxiliary control clock signal φ1ₐᵤₓ transitions high (to approximately the system potential V_{DD}), causing the auxiliary node netaux1 to rise further to approximately the potential V_{high}, by a pumping action on the first auxiliary capacitor Cₐᵤₓ₁. This causes the NMOS transistor N201 to be biased on, enabling charge transfer from the first pumping node netpump1 to the first voltage input/output node 210.

After a period of time, the charge transfer is essentially complete and a symmetrical second half period is initiated at switching transition E3, at which the auxiliary control clock signal φ1ₐᵤₓ transitions low, decreasing the auxiliary node netaux1 potential from approximately V_{high} to approximately Vₐᵤₓ. At a switching transition F3, the control clock signal φ1 transitions low, causing the first pumping node netpump1 and the auxiliary node netaux1 to decrease to approximately the potential V_{b}. This is followed by signal a transition G3, at which the control clock signal φ2 transitions high (to approximately the system potential V_{DD}), biasing the NMOS transistor N202 on, and enabling the transfer of charge from the second voltage input/output node 220 to the first pumping node netpump1. At a switching transition H3, the auxiliary control clock signal φ2ₐᵤₓ transitions high (to approximately the system potential V_{DD}), biasing the NMOS transistor N204 on, thereby enabling charge transfer from the second pumping node netpump2 to the first voltage input/output node 210. During the symmetrical second half period, charge is transferred from the second voltage input/output node 220 to the first pumping node netpump1, and from the second pumping node netpump2 to the first voltage input/output node 210.

Operation as a Negative Charge Pump

Those skilled in the art will appreciate that it is possible to conceptualize the operation of the charge pump in terms of the movement of either positive or negative charge. To preserve consistency with the conventional representation of an electric current as the motion of positive charge emanating from a positive potential toward a negative potential, the operation of the charge pump stage 200 will be described infra according to this convention. In the exemplary embodiment of the present invention operating as a negative charge pump, the potential Vₐ is applied to the first voltage input/output node 210, acting as an input. In the exemplary embodiment of the present invention, the potential Vₐ is the same as GND, where GND is nominally zero volts, as referenced to the system potential V_{DD} provided for circuit operation.

The potential V_{b} is produced at the second voltage input/output node 220 as an output. The operation of the charge pump stage 200 as a negative charge pump acts to boost the potential Vₐ to the more negative potential V_{b}. The first pump capacitor Cₚᵤₘₚ₁ and the second pump capacitor Cₚᵤₘₚ₂ provide required charge storage for the basic pumping operation. The NMOS transistors N202 and N205 are used to transfer charge from the second voltage input/output node 220 to the pumping nodes netpump1 and netpump2 respectively. By diode action, the NMOS transistors N202 and N205 further prevent reverse current feedback from the pumping nodes netpump1 and netpump2 to the second voltage input/output node 220. The NMOS transistor N201 is used to couple the first pumping node netpump1 to the potential Vₐ when the first pump capacitor Cₚᵤₘₚ₁ is not pumped, i.e., when control clock signal φ1 is high. Analogously, the NMOS transistor N204 is used to couple the second pumping node netpump2 to the potential Vₐ when the second pump capacitor Cpump2 is not pumped, that is, when control clock signal φ2 is high.

The NMOS transistor N203 is used to switch the gate terminal of the NMOS transistor N201 to the boosted pump node potential, i.e., the potential V_{b}, when the first pump capacitor Cₚᵤₘₚ₁ is boosted. In this condition, the NMOS transistor N201 has its drain terminal at approximately the potential Vₐ, and its gate, source, and bulk terminals at approximately the potential V_{b}. Since the potential Vₐ is more positive than the potential V_{b}, the NMOS transistor N201 is biased off, preventing conduction between the first voltage input/output node 210 and the first pumping node netpump1.

Analogously the NMOS transistor N206 is used to switch the gate terminal of the NMOS transistor N204 to the boosted pump node potential, i.e., the potential V_{b}, when the second pump capacitor Cₚᵤₘₚ₂ is boosted. In this condition, the NMOS transistor N204 has its drain terminal at approximately the potential Vₐ, and its gate, source, and bulk terminals at approximately the potential V_{b}. Since the potential Vₐ is more positive than the potential V_{b}, the NMOS transistor N204 is biased off, preventing conduction between the first voltage input/output node 210 and the second pump node netpump2.

The first auxiliary capacitor Cₐᵤₓ₁ is used to generate an over-shoot potential, approximately equal to the potential V_{high}, on the gate of the NMOS transistor N201. This produces a strong turn-on condition in the NMOS transistor N201 when charges are being transferred from the first pumping node netpump1 to the first input/output node 210. The second auxiliary capacitor Cₐᵤₓ₂ is used to generate an over-shoot potential V_{high} on the gate of the NMOS transistor N204, where approximately V_{high}=Vₐ−Vₜ+Cᵣ₂×V_{DD} and Cᵣ₂ has been defined supra in formula (2). This produces a strong turn-on condition in the NMOS transistor N204 when charges are being transferred from the second pumping node netpump2 to the first input/output node 210.

In steady state, the first pumping node netpump1 varies in potential between Vₐ and Vₐ−Cᵣ₁×V_{DD}, where Cᵣ₁ is defined supra in formula (1).

Following an analogous design approach to that detailed supra for the positive charge pump case, the first pump capacitor Cₚᵤₘₚ₁ is chosen so that Cₚᵤₘₚ₁∴>Cₚₐᵣ₁. As a result, Cᵣ₁ is approximately equal to unity. Under these conditions, the first pumping node netpump1 varies in potential approximately between Vₐ and Vₐ−V_{DD}. Correspondingly, the potential of the second pumping node netpump2 also varies approximately between Vₐ and Vₐ−V_{DD}, since the second pump capacitor Cₚᵤₘₚ₂ and the first pump capacitor Cₚᵤₘₚ₁ are approximately equally sized. At the end of the pumping operation on the first pumping node netpump1, when the control clock signal φ1 transitions high, but while the auxiliary control clock signal φ1ₐᵤₓ remains low, the auxiliary node netaux1 achieves a potential of approximately the potential Vₐ−Vₜ. When the auxiliary control clock signal φ1ₐᵤₓ subsequently transitions high, the potential at the auxiliary node netaux1 is driven to the overshoot value V_{high}.

In a specific exemplary embodiment of the present invention, functional operation of the negative charge pump is achieved by satisfying the same condition as stated supra for the positive charge pump, i.e., that Cᵣ₂×V_{DD}>Vₜ.

Additional details of the operation of the charge pump stage 200 as a positive voltage charge pump will now be further explained with further reference to FIG. 3. The same timing signals can be used for operation of the charge pump stage 200 as a positive charge pump and as a negative charge pump. Starting from an initial condition N where control clock signal φ1 and auxiliary control clock signal φ1ₐᵤₓ are high (at approximately the system potential V_{DD}) and control clock signal φ2 and auxiliary control clock signal φ2ₐᵤₓ are low (at approximately the ground potential GND), the second pumping node netpump2 and the auxiliary node netaux2 are at a potential of approximately Vₐ−V_{DD}. The auxiliary node netaux1 is at the potential of approximately V_{high}, and the first pumping node netpump1 is at the potential of approximately Vₐ. During the switching transition E3, the auxiliary control clock signal φ1ₐᵤₓ transitions low, causing the auxiliary node netaux1 to decrease from the potential of approximately V_{high} to the potential of approximately V_{high}−V_{DD}, as a result of the coupling of the auxiliary control clock signal φ1ₐᵤₓ to the auxiliary node netaux1 by the first auxiliary capacitor Cₐᵤₓ₁. At the switching transition F3, the control clock signal φ1 transitions low, causing the potential of the first pumping node netpump1 to decrease to approximately the potential Vₐ−V_{DD}. The auxiliary node netaux1, coupled to the first pumping node netpump1 by the NMOS transistor N203, also decreases to approximately the potential Vₐ−V_{DD}.

At the switching transition G3, the control clock signal φ2 transitions high (to approximately the system potential V_{DD}), causing the second pumping node netpump2 to rise to approximately Vₐ, biasing the NMOS transistor N202 on and enabling charge transfer from the second voltage input/output node 220 to the first pumping node netpump1. The auxiliary node netaux2 rises to approximately the potential Vₐ−Vₜ by conduction through the NMOS transistor N206. The NMOS transistor N201 and the NMOS transistor N205 have their gate terminals at a potential of approximately Vₐ−V_{DD} and are therefore biased off, preventing reverse charge transfer from the first voltage input/output node 210 to the first pumping node netpump1 and from the second pumping node netpump2 to the second voltage input/output node 220.

At the switching transition H3, the auxiliary control clock signal φ2ₐᵤₓ transitions high (to approximately the system potential V_{DD}), causing the auxiliary node netaux2 to rise further to approximately the potential V_{high}, by action on the second auxiliary capacitor Cₐᵤₓ₂. This causes the NMOS transistor N204 to be biased on, enabling charge transfer from the second pumping node netpump2 to the first voltage input/output node 210.

To summarize, during the first half period of pumping, charges are transferred from the second voltage input/output node 220 to the first pumping node netpump1 and from the second pumping node netpump2 to the first voltage input/output node 210. When charge transfer is complete, a symmetrical second half period is initiated at the switching transition A3, at which the auxiliary control clock signal φ2ₐᵤₓ transitions low, decreasing the auxiliary node netaux2 potential from approximately V_{high} to approximately V_{high}−V_{DD}. At the switching transition B3, the control clock signal φ2 transitions low, boosting the second pumping node netpump2 and the auxiliary node netaux2 (in a negative direction) to approximately the potential Vₐ−V_{DD}. This is followed by the switching transition C3, at which the control clock signal φ1 transitions high (to approximately the system potential V_{DD}), biasing the NMOS transistor N205 on, and enabling the transfer of charge from the second voltage input/output node 220 to the second pumping node netpump2. At the switching transition D3, the auxiliary control clock signal φ1ₐᵤₓ transitions high (to approximately the system potential V_{DD}), biasing the NMOS transistor N201 on, thereby enabling charge transfer from the first pumping node netpump1 to the first voltage input/output node 210. During the symmetrical second half period, charge is transferred from the second voltage input/output node 220 to the second pumping node netpump2, and from the first pumping node netpump1 to the first voltage input/output node 210.

Skilled artisans will appreciate that an important characteristic of the charge pump stage 200 is that by virtue of the triple well construction, the bulk terminal connections are enabled to deviate from the ground potential GND. Therefore the potential difference between the source, drain, gate, and bulk terminals of any of the NMOS transistors N201-N205 never exceeds approximately the system potential V_{DD} during any portion of the pumping operation. Thus, low voltage transistors can be employed to fabricate the circuit without danger of degraded device reliability or destruction due to overstressing. Additionally, the bulk terminal of each NMOS transistor is connected to the source terminal of the same transistor. This virtually eliminates the body effect, thereby precluding Vₜ modulation and a consequent reduction in stage pumping efficiency.

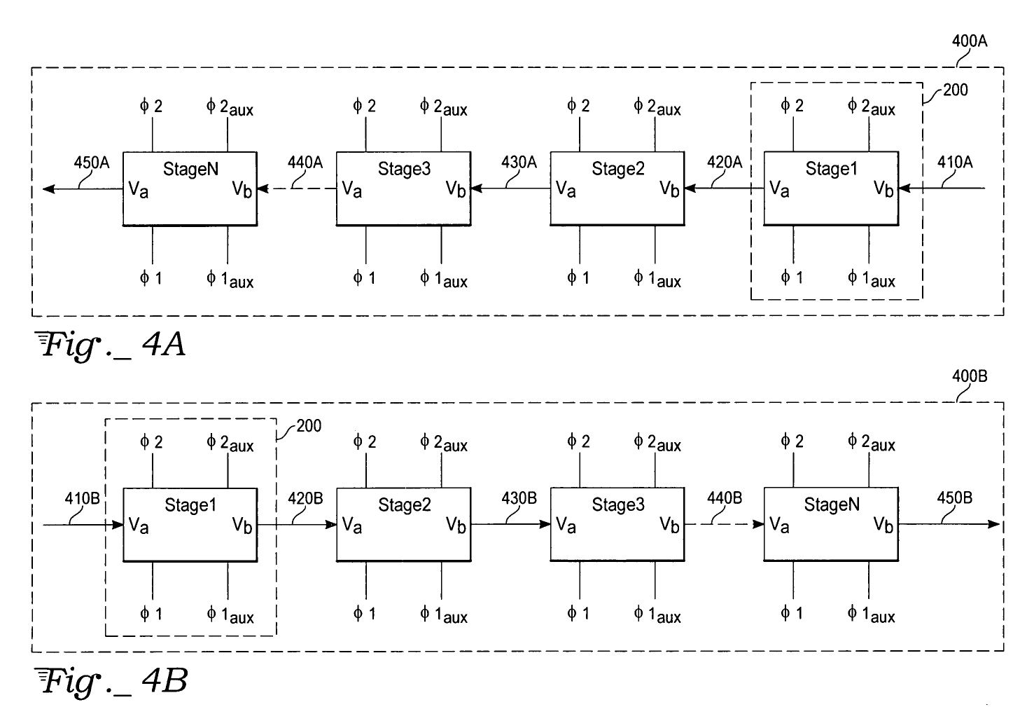

If the boosting action of a single instance of the charge pump stage 200 is not sufficient to provide a desired output potential, it is possible to cascade multiple instances of the charge pump stage 200 to achieve greater potential differences between the input and the output. Attention is now directed to FIG. 4A, a positive voltage cascaded charge pump 400A comprising a plurality of charge pump stages 200 coupled together in a cascade fashion. The positive voltage charge pump 400A further comprises a cascade positive potential input 410A which is coupled to a stage1 instantiation of the charge pump stage 200. The output of the stage1 instantiation of the charge pump 200 is increased in potential as has been described supra, and is passed by a first positive stage interconnect 420A to a stage2 instantiation of the charge pump stage 200. The potential on the first positive stage interconnect 420A is approximately:
Vₐ=V_{b}+Cᵣ₁×V_{DD} (3)

where it is assumed that the parasitic capacitance effects are as explained supra. The stage2 instantiation of the charge pump stage 200 further boosts the potential, passing the output by a second positive stage interconnect 430A to a stage3 instantiation of the charge pump stage 200. The potential on the second positive stage interconnect 430A is approximately:
Vₐ=V_{b}+2Cᵣ₁×V_{DD} (4)

The cascading process can be continued with additional positive stage instances 440A, an input of each additional stage coupled to an output of a preceding stage, where the dotted line is intended to signify a plurality of intervening charge pump stages 200 and stage interconnects. After cascading N instances of the charge pump stage 200, the output is provided to cascade positive potential output 450A. The total potential boost, that is, the potential on the cascade positive potential output 450A, is approximately:
Vₐ=V_{b}+N·Cᵣ₁×V_{DD} (5)

In the positive voltage cascaded charge pump 400A, the gain per stage is limited primarily by parasitic capacitance, and can be made very close to V_{DD} in actual practice. In an exemplary embodiment of the present invention, fabricated with a commercial CMOS process using 0.18 μm channel length devices, an output potential of 15 V was realized with an eleven stage positive charge pump operating on input potential of 1.3 V. This represents an approximately 96% average V_{DD} gain per stage.

Attention is now directed to FIG. 4B, a negative voltage cascaded charge pump 400B comprising a plurality of charge pump stages 200 coupled together in a cascade fashion. The negative voltage charge pump 400B further comprises a cascade negative potential input 410B which is coupled to a stage1 instantiation of the charge pump stage 200. The output of the stage1 instantiation of the charge pump stage 200 is decreased in potential (that is, made more negative) as has been described supra, and is passed by a first negative stage interconnect 420B to a stage2 instantiation of the charge pump stage 200. The potential on the first negative stage interconnect 420B is approximately:
V_{b}=Vₐ−Cᵣ₁×V_{DD} (5)

where it is assumed that the parasitic capacitance effects are as explained supra. The stage2 instantiation of the charge pump stage 200 further decreases the potential, passing the output by a second negative stage interconnect 430B to a stage3 instantiation of the charge pump stage 200. The potential on the second negative stage interconnect 430B is approximately:
V_{b}=Vₐ−2Cᵣ₁×V_{DD} (6)

The cascading process can be continued with additional negative stage instances 440B, an input of each additional stage coupled to an output of a preceding stage, where the dotted line is intended to signify a plurality of intervening charge pump stages 200 and stage interconnects. After cascading N instances of the charge pump stage 200, the output is provided to cascade negative potential output 450B. The total potential boost, that is, the potential on the cascade positive potential output 450B, is approximately:
V_{b}=Vₐ−N·Cᵣ₁×V_{DD} (5)

In the negative voltage cascaded charge pump 400B, the gain per stage is limited primarily by parasitic capacitance, and can be made very close to −V_{DD} in actual practice. In an exemplary embodiment of the present invention, fabricated with a commercial CMOS process using 0.18 μm channel length devices, an output potential of −13.7 V was realized with an eleven stage negative charge pump operating on input potential of GND. This represents an approximately 97% average −V_{DD} gain per stage.

Those skilled in the art will appreciate that the positive voltage cascaded charge pump 400A and the negative voltage cascaded charge pump 400B can be identical circuit implementations based upon the charge pump stage 200. Furthermore, skilled artisans will recognize that operation as a positive or as a negative charge pump merely depends upon whether a positive potential is applied as the input to the plurality of cascaded charge pump stages 200 by means of the cascade positive potential input 410A or a GND potential is applied as the input by means of the cascade negative potential input 410B. Thus, the charge pump stage 200 is bi-directional, meaning that both positive and negative potentials can be generated with the same circuitry. This provides an important area savings, for example in the fabrication of Flash memories. Another important attribute of the charge pump stage 200 is that same clocking configuration is usable for both the positive and the negative charge pump configurations. This simplifies the design of the timing generation circuit.

In the foregoing specification, the invention has been described with reference to specific embodiments thereof. It will, however, be evident to a skilled artisan that various modifications and changes can be made thereto without departing from the broader spirit and scope of the invention as set forth in the appended claims. For example, the charge pump stage 200 may be fabricated having each NMOS transistor within a separate triple well structure, or those transistors having similar bulk terminal potentials (such as N204 and N206) may occupy a common triple well. Other components, e.g., the capacitors, may optionally be included within the circuit on a single substrate or may be fabricated externally. The specification and drawings are, accordingly, to be regarded in an illustrative rather than a restrictive sense.

What is claimed is:

1. A charge pump circuit comprising:
a first voltage node, the first voltage node acting as an input when the charge pump circuit boosts negative voltages, and acting as an output when the charge pump circuit boosts positive voltages;
a second voltage node, the second voltage node acting as an input when the charge pump circuit boosts positive voltages, and acting as an output when the charge pump circuit boosts negative voltages;
a first pump capacitor having a first terminal and a second terminal, the first terminal coupled to a first pump node and the second terminal coupled to a first pump clock input node;
a second pump capacitor having a first terminal and a second terminal, the first terminal coupled to a second pump node and the second terminal coupled to a second pump clock input node;
a first auxiliary capacitor having a first terminal and a second terminal, the first terminal coupled to a first auxiliary signal node and the second terminal coupled to a first auxiliary clock input node;
a second auxiliary capacitor having a first terminal and a second terminal, the first terminal coupled to a second auxiliary signal node and the second terminal coupled to a second auxiliary clock input node;
a first NMOS transistor, the first NMOS transistor having source, gate, drain, and bulk terminals, the drain terminal coupled to the first voltage node, the source terminal and the bulk terminal coupled to the first pump node;
a second NMOS transistor, the second NMOS transistor having source, gate, drain, and bulk terminals, the source terminal and the bulk terminal coupled to the second voltage node, the drain terminal coupled to the first pump node, and the gate terminal coupled to the second pump node;
a third NMOS transistor, the third NMOS transistor having source, gate, drain, and bulk terminals, the gate terminal coupled to the first voltage node, the drain terminal coupled to the gate terminal of the first NMOS transistor and to the first auxiliary signal node, and the source terminal and the bulk terminal coupled to the first pump node;
a fourth NMOS transistor, the fourth NMOS transistor having source, gate, drain, and bulk terminals, the drain terminal coupled to the first voltage node, the source terminal and the bulk terminal coupled to the second pump node;
a fifth NMOS transistor, the fifth NMOS transistor having source, gate, drain, and bulk terminals, the source terminal and the bulk terminal coupled to the second voltage node, the drain terminal coupled to the second pump node, and the gate terminal coupled to the first pump node; and
a sixth NMOS transistor, the sixth NMOS transistor having source, gate, drain, and bulk terminals, the gate terminal coupled to the first voltage node, the drain terminal coupled to the gate terminal of the fourth NMOS transistor and to the second auxiliary signal node, and the source terminal and the bulk terminal coupled to the second pump node.

2. The charge pump circuit of claim 1 wherein:
the first, second, third, fourth, fifth, and sixth NMOS transistors are fabricated in a triple well.

3. The charge pump circuit of claim 2 wherein:
the first, second, third, fourth, fifth, and sixth NMOS transistors are low voltage transistors.

4. A charge pump circuit comprising:
a first voltage node, the first voltage node acting as an output for an output potential when the charge pump circuit boosts positive voltages;
a second voltage node, the second voltage node acting as an input for an input potential when the charge pump circuit boosts positive voltages;
a first NMOS transistor, the first NMOS transistor fabricated in a triple well and configured to couple the first voltage node and a first pumping capacitor, the first NMOS transistor further having a source terminal and a bulk terminal coupled to each other;
a second NMOS transistor, the second NMOS transistor fabricated in a triple well and configured to couple the first voltage node and a second pumping capacitor, the second NMOS transistor further having a source terminal and a bulk terminal coupled to each other;
a first auxiliary capacitor coupled to a gate terminal of the first NMOS transistor, the first auxiliary capacitor configured to produce a control potential on the gate terminal of the first NMOS transistor when the charge pump circuit boosts positive voltages, the control potential being more positive than the output potential during a first pumping half-period; and
a second auxiliary capacitor coupled to a gate terminal of the second NMOS transistor, the second auxiliary capacitor configured to produce a control potential on the gate terminal of the second NMOS transistor when the charge pump circuit boosts positive voltages, the control potential being more positive than the output potential during a second pumping half-period.

5. A charge pump circuit comprising:
a first voltage node, the first voltage node acting as an input for an input potential when the charge pump circuit boosts negative voltages;
a second voltage node, the second voltage node acting as an output for an output potential when the charge pump circuit boosts negative voltages;
a first NMOS transistor, the first NMOS transistor fabricated in a triple well and configured to couple the first voltage node and a first pumping capacitor, the first NMOS transistor further having a source terminal and a bulk terminal coupled to each other;
a second NMOS transistor, the second NMOS transistor fabricated in a triple well and configured to couple the first voltage node and a second pumping capacitor, the second NMOS transistor further having a source terminal and a bulk terminal coupled to each other;
a first auxiliary capacitor coupled to a gate terminal of the first NMOS transistor, the first auxiliary capacitor configured to produce a control potential on the gate terminal of the first NMOS transistor, the control potential being more positive than the input potential during a first pumping half-period; and
a second auxiliary capacitor coupled to a gate terminal of the second NMOS transistor, the second auxiliary capacitor configured to produce a control potential on the gate terminal of the second NMOS transistor, the control potential being more positive than the input potential during a second pumping half-period.

6. A method for operating a charge pump, the method comprising:
coupling a pump capacitor to an input/output terminal by means of an NMOS transistor fabricated in a triple well;
coupling a source terminal and a bulk terminal of the NMOS transistor to each other and to the pumping capacitor to minimize the NMOS transistor's body effect;
raising a turn-on potential on a gate terminal of the NMOS transistor to a value which is more positive than a most positive of an input potential and an output potential during a portion of a charge pumping cycle; and
limiting a potential difference between the gate terminal and the source terminal of the NMOS transistor to a maximum of approximately equal to a system supply potential.

7. The method of claim 6, further comprising limiting the potential difference between any two terminals of the source terminal, the gate terminal, the drain terminal, and the bulk terminal of the NMOS transistor to a maximum of approximately equal to a system supply potential.

8. The method of claim 7, wherein the step of raising the turn-on potential on the gate terminal of the NMOS transistor comprises:
coupling an auxiliary capacitor node to the gate terminal;
charging the auxiliary capacitor node to a potential approximately equal to the most positive of the input potential and the output potential; and
increasing the potential of the auxiliary capacitor node to a more positive value by applying an auxiliary clock signal to a second auxiliary capacitor node.

9. A method for operating a charge pump, the method comprising:
applying a first input potential to a first input/output node when operating the charge pump as a negative charge pump;
receiving a negative output potential, the negative output potential being more negative than the first input potential, from a second input/output node when operating the charge pump as a negative charge pump;
applying a second input potential to the second input/output node when operating the charge pump as a positive charge pump;
receiving a positive output potential, the positive output potential being more positive than the second input potential, from the first input/output node when operating the charge pump as a positive charge pump;
coupling the first input/output terminal and the second input/output terminal by NMOS transistors fabricated in a triple well, the NMOS transistors each further having a source terminal coupled to a bulk terminal;
controlling a conduction of at least one of the NMOS transistors with a potential more positive than the positive output potential when operating the charge pump as a positive charge pump; and
controlling the conduction of at least one of the NMOS transistors with a potential more positive than the first input potential when operating the charge pump as a negative charge pump.

10. The method of claim 9, wherein the first input potential is a system ground (GND) potential and the second input potential is more positive than the system ground (GND) potential.

11. A charge pump circuit comprising:
a first voltage input/output terminal;
a second voltage input/output terminal;
a first switching means for coupling the first voltage input/output terminal to a first charge storage device, the first switching means fabricated in a triple well;
a second switching means for coupling the first voltage input/output terminal to a second charge storage device, the second switching means fabricated in a triple well;
a third switching means for coupling the first charge storage device to the second voltage input/output terminal, the third switching means fabricated in a triple well;
a fourth switching means for coupling the second charge storage device to the second input/output terminal, the fourth switching means fabricated in a triple well;
timing means for controlling an on/off condition in the first, second, third, and fourth switching means such that while the first switching means and the fourth switching means are in an on condition, the second switching means and the third switching means are in an off condition, the timing means further controlling the on/off condition such that while the first switching means and the fourth switching means are in an off condition, the second switching means and the third switching means are in an on condition; and
overshoot means for providing a control potential on the first switching means and the second switching means to a value which exceeds the range defined by an input potential provided to the charge pump and an output potential provided by the charge pump.

12. A charge pump circuit comprising:
a plurality of charge pump stages, each charge pump stage further comprising:
a first voltage node, the first voltage node acting as an input when the charge pump circuit boosts negative voltages, and acting as an output when the charge pump circuit boosts positive voltages;
a second voltage node, the second voltage node acting as an input when the charge pump circuit boosts positive voltages, and acting as an output when the charge pump circuit boosts negative voltages;
a first pump capacitor having a first terminal and a second terminal, the first terminal coupled to a first pump node and the second terminal coupled to a first pump clock input node;
a second pump capacitor having a first terminal and a second terminal, the first terminal coupled to a second pump node and the second terminal coupled to a second pump clock input node;
a first auxiliary capacitor having a first terminal and a second terminal, the first terminal coupled to a first auxiliary signal node and the second terminal coupled to a first auxiliary clock input node;
a second auxiliary capacitor having a first terminal and a second terminal, the first terminal coupled to a second auxiliary signal node and the second terminal coupled to a second auxiliary clock input node;
a first NMOS transistor, the first NMOS transistor having source, gate, drain, and bulk terminals, the drain terminal coupled to the first voltage node, the source terminal and the bulk terminal coupled to the first pump node;
a second NMOS transistor, the second NMOS transistor having source, gate, drain, and bulk terminals, the source terminal and the bulk terminal coupled to the second voltage node, the drain terminal coupled to the first pump node, and the gate terminal coupled to the second pump node;
a third NMOS transistor, the third NMOS transistor having source, gate, drain, and bulk terminals, the gate terminal coupled to the first voltage node, the drain terminal coupled to the gate terminal of the first NMOS transistor and to the first auxiliary signal node, and the source terminal and the bulk terminal coupled to the first pump node;
a fourth NMOS transistor, the fourth NMOS transistor having source, gate, drain, and bulk terminals, the drain terminal coupled to the first voltage node, the source terminal and the bulk terminal coupled to the second pump node;
a fifth NMOS transistor, the fifth NMOS transistor having source, gate, drain, and bulk terminals, the source terminal and the bulk terminal coupled to the second voltage node, the drain terminal coupled to the second pump node, and the gate terminal coupled to the first pump node; and
a sixth NMOS transistor, the sixth NMOS transistor having source, gate, drain, and bulk terminals, the gate terminal coupled to the first voltage node, the drain terminal coupled to the gate terminal of the fourth NMOS transistor and to the second auxiliary signal node, and the source terminal and the bulk terminal coupled to the second pump node.

13. The charge pump of claim 10 wherein:
the first, second, third, fourth, fifth, and sixth NMOS transistors are fabricated in a triple well.

14. The charge pump of claim 11 wherein:
the first, second, third, fourth, fifth, and sixth NMOS transistors are low voltage transistors.
